(19) United States
(12) Patent Application Publication
(10) Pub. No.: US 2010/0199862 A1
(43) Pub. Date: Aug. 12, 2010

(54) Apparatus for Filling and/or Treatment of Paste-Like Masses, In Particular Sausage Meat

(75) Inventors: Tobias Kiel, Verden (DE); Kersten Nilsson, Verden (DE)

Correspondence Address: WOOD, HERRON & EVANS, LLP, 2700 CAREW TOWER, 441 VINE STREET, CINCINNATI, OH, 45202, US

(73) Assignee: VEMAG Maschinenbau GMbH, Verden/Aller (DE)

(21) Appl. No.: 12/641,365

(22) Filed: Dec. 18, 2009

(30) Foreign Application Priority Data
Dec. 18, 2008 (DE) 20 2008 016 702.7

(51) Int. Cl. A22C 11/02

(52) U.S. Cl. 99/485

(57) ABSTRACT

The invention concerns an apparatus for processing and filling a pasty material such as sausage meat, in particular for coupling to an apparatus for filling pasty material, comprising a housing having an inlet for introduction of the material and an outlet for discharge of the material, and an insert which can be inserted into the housing and which is adapted to process and/or influence material flowing through the housing. It is in accordance with the invention that provided in the housing between the inlet and the outlet is an opening through which the insert can be inserted into and removed from the housing and the opening is closable by means of a closure.

### BACKGROUND

The present invention concerns a processing apparatus and a filling machine for filling pasty materials, in particular sausage meat.

Filling machines of the kind set forth in the opening part of this specification serve for filling pasty foodstuff materials in packagings. Thus such filling machines can be used for filling meat products such as sausage meat which is to be heated in water, ground meat, small sausages or other sausage products into cases of natural or synthetic casing skin. The filling machine has a filling hopper for receiving the material, a conveyor pump and a tube for delivery of the material. It is possible to connect downstream of the filling machine for example clippers for clamping off ends of a sausage portion, filling flow dividers for dividing up the flow of material into a plurality of individual flow portions or other so-called accessory devices which can be coupled to a filling machine.

An example of a processing apparatus of the aforementioned kind is an apparatus for distributing gas, in particular air bubbles, within sausage meat, which is suitable for example for the production of sausages to be heated in water. Introducing such sausage materials can involve an agglomeration of the air present in the sausage meat, that is to say the formation of relatively large air bubbles within the sausage meat, which however are unwanted in the sausage product by the customer and are not accepted. For finely distributing any air in the sausage meat, a known processing apparatus which is connected downstream of the filling machine has a nozzle which is arranged in a tube. The nozzles which are approximately in the shape of a cylindrical tube with a reduction in cross-section in the interior are axially inserted into a substantially tubular housing and are fixed within the tube. The reduction in cross-section within the nozzle results in large air bubbles being reduced in size and thus entails finer distribution of air within the sausage meat. The tube with inserted nozzle is connected by means of a screw connection on the one hand at the intake side to the discharge tube of the filling machine and on the other hand at the outlet side to a downstream-connected accessory device, for example a clipper.

In the case of a change in product the nozzle is generally also to be changed. The nozzle used must be of a specific internal structure, in particular being of a specifically adapted inside diameter, in dependence on the kind of product. That is required to adapt the flow conditions prevailing, to the product. Thus for example substantially solid inclusions such as mushrooms or the like may be present in the sausage meat, which when an incorrect nozzle is used, could be damaged or destroyed. Installation and replacement is comparatively complicated and expensive as the complete tube which accommodates the nozzle and which is screwed at both ends has to be unscrewed. A number of screw connections have to be released for that purpose. When the tube is released a fresh nozzle is axially pushed into place through an end of the tube. The tube with inserted nozzle is then screwed in place again. The relatively high level of complication and expenditure involved in changing a nozzle is perceived by users as being a disadvantage.

### BRIEF SUMMARY

Therefore, an object of the present invention is to provide a processing apparatus and a filling apparatus which reduce the disadvantages present in the state of the art and which in particular permit rapid adaptation to different products. In particular the invention seeks to provide a processing or filling apparatus which permits comparatively simple replacement of nozzles through which the material flows.

With a processing apparatus of the kind set forth herein, the invention attains that object in that provided in the housing between the inlet and the outlet is an opening through which the insert can be inserted into and removed from the housing and the opening is closable by means of a closure.

The invention further attains the object with a filling apparatus of the kind set forth herein, which is connected to a processing apparatus according to the invention.

According to the invention, the insert for processing of the material can be inserted, removed and thus replaced, easily and with a small amount of time involvement. That is effected by way of the (additional) opening in the housing, through which the insert, for example a nozzle, can be exchanged, without the entire housing having to be unscrewed, as is the case in the state of the art. The connection of the housing to a filling machine on the one hand and to downstream-disposed processing devices (so-called accessory devices) on the other hand is thus maintained in accordance with the invention, when changing the insert. That affords a considerable advantage in terms of time and cost.

A particularly preferred embodiment of the invention has a receiving device for receiving the insert, which can be at least partially fitted into the housing together with the insert through the opening to position the insert within the housing. Such a receiving device which accommodates the insert means that the operation of changing an insert which is preferably a nozzle can be effected particularly easily and quickly insofar as the complete receiving device with insert (preferably nozzle) is removed and inserted respectively. At the same time, the receiving device can be of such a configuration that the insert is securely positioned thereon and thus the insert is positioned precisely within the flow passage which is provided in the housing and through which the pasty material is conveyed so that the flow occurs in the most optimum possible fashion, for example only with low levels of flow resistance and not excessive shearing forces.

An aspect provides that the receiving device has a closure portion which closes the opening in the inserted condition and a receiving portion which projects into the housing in the inserted condition and to which the insert can be fixed. The closure portion and the receiving portion can be provided on an integral component, for example a turned and/or milled component, or can also be welded together or secured together in some other way.

In a further alternative embodiment, it is proposed that the housing is substantially in the form of a cylindrical tube which is permanently closed at its one end and has the opening at the other end, and the receiving portion of the receiving device is substantially tubular and has two oppositely disposed through bores into which the insert can be inserted, and the closure portion of the receiving device is in the form of a substantially circular closure plate. In that way the apparatus is optimised in terms of production engineering and flow technology and handling can be reliably implemented.

Coupling to a filling apparatus (filling machine) on the one hand and an accessory device which can be for example a clipper, filling flow divider or the like, can be advantageously implemented if a first tube connection having the inlet and a second tube connection having the outlet are arranged on the housing.

In accordance with a further preferred embodiment, it is proposed that the receiving device can be fixed to the housing by way of a bayonet fastening or screw fastenings as that can assist with rapid release or fixing.

Handling is further improved in that a blind bore is centrally provided at the closure plate of the receiving device, into which blind bore a handling tool can be inserted in positively locking relationship for withdrawing or introducing the receiving device. The handling tool can be for example a T-shaped hand tool which with its free end engages the receiving device.

In an aspect, it is proposed that projections which serve for fixing within the housing are provided in the edge region of the closure portion so that positioning is achieved at the same time by means of the projections.

A particularly preferred alternative embodiment is distinguished in that the insert is in the form of a substantially rotationally symmetrical nozzle through which the material flows in operation, wherein the nozzle is so arranged within the housing that its longitudinal axis is arranged substantially perpendicularly to the longitudinal axis of the housing and coaxially with the two tube connections. The nozzle is respectively adapted to the particular conditions of the product and optimised in terms of flow technology and securely positioned between the tube connections within the housing.

A desirable aspect provides that in the inserted condition the nozzle comes to bear against an abutment which is provided on the receiving portion of the receiving device and which is arranged downstream of the nozzle in the flow direction. With an abutment arranged in such a way the nozzle can be inserted from one side and securely positioned against the abutment, wherein in operation the flow provides for a kind of biasing effect in a direction towards the abutment so that the nozzle is reliably positioned.

In accordance with a further aspect, the invention also attains the object with a filling apparatus (filling machine) which co-operates with an above-described processing apparatus. In regard to the advantages which can be achieved in accordance with the invention with such a filling apparatus attention is directed to the foregoing description. It is particularly preferred for such a filling apparatus to be coupled to a processing apparatus having a nozzle which can be easily inserted, being of such a configuration that gas inclusions within sausage meat or other pasty foodstuff materials are distributed within the sausage meat, that is to say a kind of homogenisation is achieved by means of a simple flow nozzle.

In accordance with an aspect of the filling apparatus, it is proposed that the filling tube of the filling machine is coupled to a tube connection of the processing apparatus and a tube connection of the processing apparatus, that has an outlet, is coupled to a further accessory device such as for example a clipper, a filling flow divider or the like.

### BRIEF DESCRIPTION OF THE SEVERAL VIEWS OF THE DRAWINGS

The invention is described hereinafter by means of a preferred embodiment by way of example of a filling apparatus (filling machine) and a processing apparatus with an insertable nozzle with reference to the drawings in which:

FIG. 1 shows a side view of a filling machine with coupled processing apparatus and downstream-connected accessory device,

FIG. 2 shows an exploded perspective view of a processing apparatus according to the invention, and

FIG. 3 shows a view in longitudinal section of the processing apparatus shown in FIGS. 1 and 2.

### DETAILED DESCRIPTION

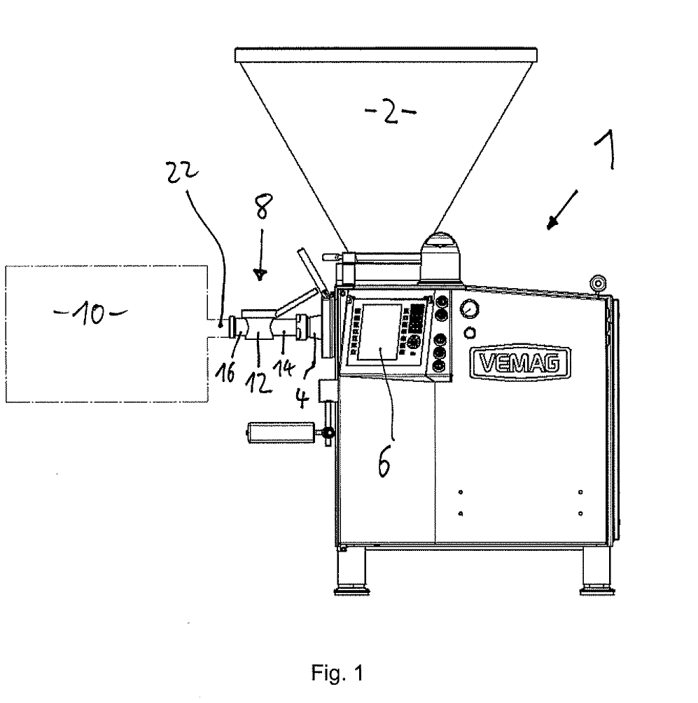

The apparatus shown as a side view in FIG. 1 for filling pasty materials, also referred to as a filling machine 1, is in the form of a vacuum filling machine and serves for filling sausage meat. It has inter alia a hopper-shaped supply container 2 for receiving and storing the meat or other pasty material such as dough. A filling pump (not shown) conveys the pasty material into a filling tube 4 or filling tube holder 4 for discharge of the material from the filling machine 1. At its free end the filling tube 4 has a male screwthread. The filling machine 1 can be controlled by means of a control system and operating panel 6.

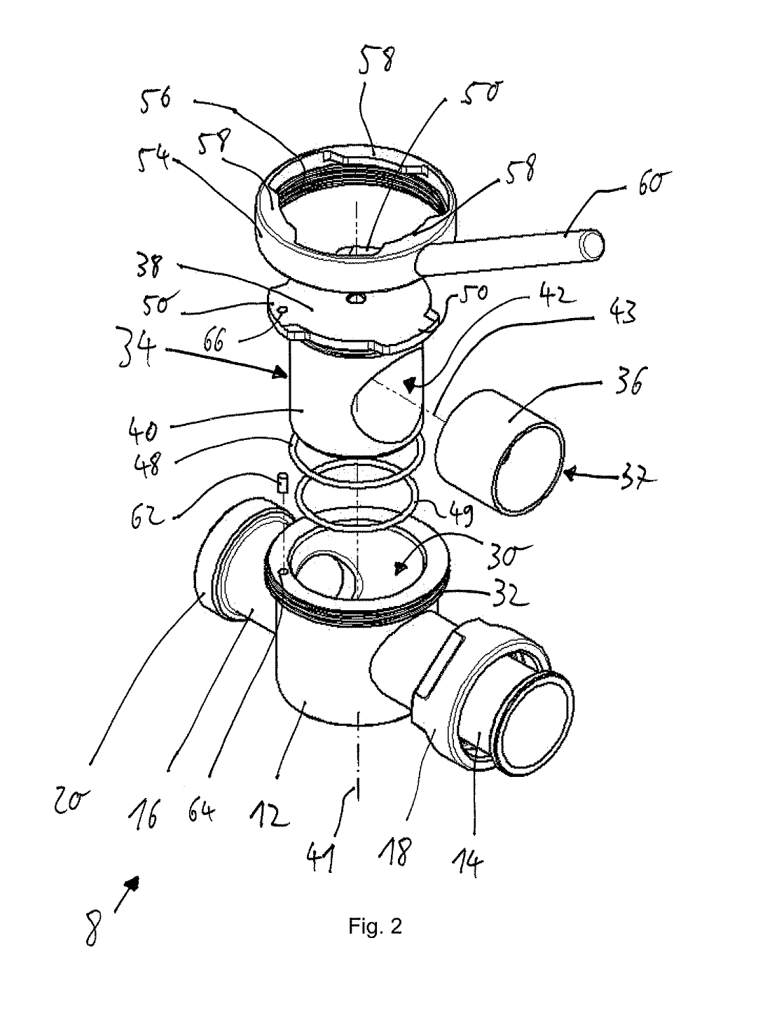

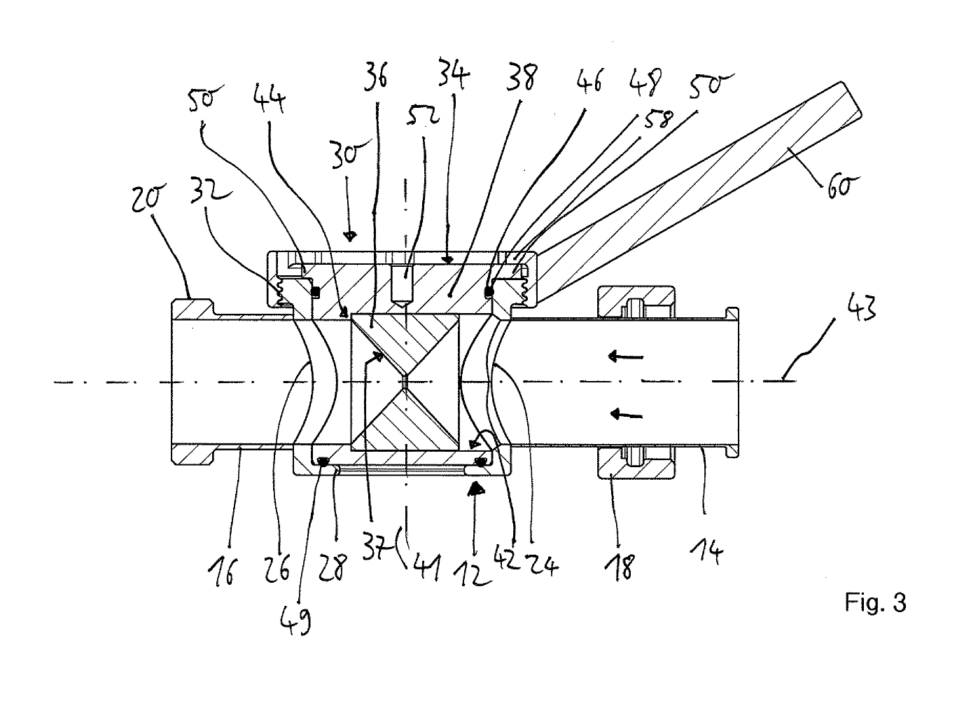

An apparatus 8 for processing the pasty material is coupled in the illustrated embodiment to the filling machine but it could also be coupled to another pump for conveying a pasty foodstuff material or connected to a conduit through which the pasty material can be conveyed. The processing apparatus 8, also shown in FIGS. 2 and 3, serves generally for processing the material flowing therethrough. Specifically in the illustrated embodiment it serves for more finely distributing gas inclusions, in particular air inclusions within the sausage meat by means of insertable nozzles which are described hereinafter in greater detail. It could however also effect other sausage meat processing operations by means of an insert, for example mixing.

Connected downstream of the processing apparatus 8 in the direction of flow of the material is a so-called accessory device 10 which in the illustrated embodiment is a so-called clipper for dividing up and closing individual sausage portions. Alternatively it could also be in the form of a filling flow divider, mincer or the like.

The processing apparatus 8 has a housing 12 and two oppositely disposed tube connections 14, 16 which are fixed thereto and to the free ends of which coupling to the filling machine 1 and the accessory device 10 is effected so that the material can be conveyed from the filling machine 1 into the processing apparatus 8 and from there into the accessory device 10. The coupling is made by screw connections by means of union nuts and male screwthreads. As FIGS. 1 and 2 show a union nut 18 is provided on the tube connection 14 for making a connection to a male screwthread on the filling tube 4. Provided at the free end of the tube connection 16 is a male screwthread 20 which can be connected to a tube connection 22 (FIG. 1) of the accessory device 10 by means of a further union nut (not shown).

As FIGS. 2 and 3 show the housing 12 which is arranged between the tube connections 14, 16 has at an end of the tube connection 14 an inlet 24 for introduction of the material into the interior of the housing 12 and an outlet 26 coinciding with an end of the tube connection 16 for discharge of the material from the housing 12. The housing 12 which is welded or screwed to the tube connections 14, 16 is substantially in the form of a cylindrical tube or tube portion, the lower end of which is permanently closed by a closure plate 28. Opposite the closure plate 28 the housing 12 has an opening 30 which is closable by means of a closure, and a screwthread 32 on the outside.

A one-piece receiving device 34 serves to receive an insert 36, in the illustrated embodiment in the form of a nozzle 37, which influences the material flowing therethrough. The receiving device 34 has an upper closure portion 38 which in the fitted condition shown in FIG. 3 completely closes the opening 30 of the housing 12, and a lower receiving portion 40 which receives the nozzle 37 and in the assembled inserted condition projects substantially into the interior of the housing 12. The receiving device 34 and the insert 36 in the form of the nozzle 37 are inserted together through the opening in a substantially radial direction so that the material can flow through the nozzle 37. At the same time the insert 36 is positioned within the housing 12.

The substantially cylindrical tubular receiving portion 40 is arranged concentrically relative to the longitudinal axis 41 of the housing 12. The rotationally symmetrical nozzle 36 is arranged with its longitudinal axis 43 which at the same time is the longitudinal axis of the tube connections 14 and 16, substantially perpendicularly to the longitudinal axis 41 of the housing 12 and coaxial with the two tube connections 14, 16. Provided in the receiving portion 40 of the receiving device 34 is a cylindrical bore 42 into which the externally cylindrical nozzle 37 is inserted, and an abutment 44 in the form of a shoulder which serves to provide that the nozzle 37 in the inserted condition comes to bear thereagainst, being arranged completely within the bore 42. The nozzle 37 is internally of a portion-wise conically tapering configuration and a portion-wise conically enlarging configuration in the material flow direction. At opposite wall portions, the wall of the receiving portion has respective through bores 42 so that the insert 36 can be inserted and is positioned at the same time.

The closure portion 38 is in the form of a substantially circular closure plate which completely closes the opening 30. Fitted into a peripheral groove 46 is an O-ring 48 for sealing purposes. A further seal is afforded by means of an O-ring 49. Provided at the outer edge are three uniformly spaced, externally slightly rounded-off projections 50 which in the assembled condition come to bear against the upper edge of the housing 12. Provided centrally in the closure plate is a blind bore 52 provided with a female screwthread so that a handling tool with a male screwthread can be screwed in, in order to be able to insert the receiving device 34 together with the insert 38, by introduction in the direction of the longitudinal axis 41, or to be able to remove it in the opposite direction.

A union nut 54 can be screwed on to the male screwthread 32 on the housing 12 so that the receiving device 34 is secured in the FIG. 3 position in the assembled condition. The union nut 54 has a female screwthread 56, an opening and three inwardly projecting uniformly spaced projections 58 co-operating with the projections 50. A radially and slightly upwardly angularly projecting straight cylindrical handle 60 serves for manual rotation of the union nut 54 into its tightened closure position or an open position in which the projections 58 are not arranged in alignment with the projections 50. The entire receiving device 34 with insert 36 can be withdrawn in that position.

As FIG. 2 shows a cylindrical pin 62 provides that the inserted receiving device 34 is positioned non-rotatably with respect to the longitudinal axis 41. The pin 62 is pressed into a cylindrical opening 64 in the housing 12. Provided in the region of a projection 50 is a cylindrical bore 66 into which the pin 62 can engage.

The mode of operation of the filling machine 1 and the processing apparatus 8 is as follows:

A nozzle 37 suited to the material to be processed and to the operating conditions is firstly inserted into the bore 42 until it comes to bear against the abutment 44. The entire receiving device with inserted nozzle 37 is then inserted completely into the housing 12 through the opening 30. The union nut 54 is then turned by rotation of the handle 60 so that it is firmly tightened. The filling machine 1 can then be switched on so that sausage meat is conveyed in the direction of the arrows, FIG. 3, through the tube connection 14 and through the inner free, conically narrowing and then enlarging flow cross-section of the nozzle 37 so that any air inclusions within the sausage meat are distributed. The sausage meat further flows through the tube connection 16 into the accessory device 10. If the properties of the sausage meat change, for example because a different sausage meat is to be processed, the union nut 54 is released, the receiving device 34 together with the nozzle 37 is withdrawn, another suited nozzle 37 of a different flow cross-section is inserted into the bore 42 and then the entire receiving device 34 is fitted into the housing again, as described hereinbefore.

1-12. (canceled)

13. An apparatus for use in processing a food material, the apparatus comprising:
a housing having an inlet for introducing the food material, an outlet for discharge of the material, and an opening in the housing disposed between the inlet and the outlet; and
an insert configured to be inserted through the opening into the housing and to be removed through the opening from the housing, the insert adapted to process and/or influence material flowing through the housing.

14. The apparatus of claim 13 further comprising:
a receiving device for receiving the insert, the receiving device configured to be at least partially fitted into the housing together with the insert through the opening such that the insert is positioned within the housing.

15. The apparatus of claim 14 wherein the receiving device includes a closure portion that closes the opening in the inserted condition and a receiving portion that projects into the housing in the inserted condition, the insert configured to be fixed to the receiving portion.

16. The apparatus of claim 14 wherein the housing is substantially in the form of a cylindrical tube having a first end that is permanently closed and a second end that includes the opening, the receiving portion of the receiving device is substantially tubular and has two oppositely disposed through bores into which the insert can be inserted, and the closure portion of the receiving device is in the form of a substantially circular closure plate.

17. The apparatus of claim 14 wherein the receiving device can be fixed to the housing by a bayonet fastening or screw fastenings.

18. The apparatus of claim 14 wherein the closure plate of the receiving device includes a centrally-located blind bore, the blind bore configured to receive a handling tool that can be inserted in positively locking relationship for withdrawing or introducing the receiving device.

19. The apparatus of claim 14 wherein the closure portion includes an edge region and a plurality of projections in the edge region that serve for fixing the receiving device within the housing.

20. The apparatus of claim 13 wherein a first tube connection having the inlet and a second tube connection having the outlet are arranged on the housing.

21. The apparatus of claim 20 wherein the insert is in the form of a substantially rotationally symmetrical nozzle through which the material flows in operation, and the nozzle is so arranged within the housing such that a longitudinal axis of the nozzle is arranged substantially perpendicularly to a longitudinal axis of the housing and coaxially with the first and second tube connections.

22. The apparatus of claim 21 wherein, in the inserted condition, the nozzle comes to bear against an abutment which is provided on the receiving portion of the receiving device and which is arranged downstream of the nozzle in the flow direction.

23. An apparatus for filling pasty materials, in particular sausage meat, comprising
a preferably hopper-shaped supply container for receiving the material;
a filling pump for conveying the pasty material;
a filling tube communicating with the filling pump for discharge of the material to be filled;
a processing apparatus communicating with the filling tube for processing the pasty material, the processing apparatus including a housing having an inlet for introducing the food material, an outlet for discharge of the material, and an opening in the housing disposed between the inlet and the outlet; and
an insert configured to be inserted through the opening into the housing and to be removed through the opening from the housing, the insert adapted to process and/or influence material flowing through the housing of the processing apparatus.

24. The apparatus of claim 23 wherein the processing apparatus includes a first tube connection and a second tube connection, the filling tube of the filling machine is coupled to the first tube connection of the processing apparatus, and the second tube connection of the processing apparatus has an outlet is coupled to a further accessory device.

25. The apparatus of claim 23 further comprising:
a receiving device for receiving the insert, the receiving device configured to be at least partially fitted into the housing together with the insert through the opening such that the insert is positioned within the housing.

26. The apparatus of claim 25 wherein the receiving device includes a closure portion that closes the opening in the inserted condition and a receiving portion that projects into the housing in the inserted condition, the insert configured to be fixed to the receiving portion.

27. The apparatus of claim 25 wherein the housing is substantially in the form of a cylindrical tube having a first end that is permanently closed and a second end that includes the opening, the receiving portion of the receiving device is substantially tubular and has two oppositely disposed through bores into which the insert can be inserted, and the closure portion of the receiving device is in the form of a substantially circular closure plate.

28. The apparatus of claim 25 wherein the receiving device can be fixed to the housing by a bayonet fastening or screw fastenings.

29. The apparatus of claim 25 wherein the closure plate of the receiving device includes a centrally-located blind bore, the blind bore configured to receive a handling tool that can be inserted in positively locking relationship for withdrawing or introducing the receiving device.

30. The apparatus of claim 25 wherein the closure portion includes an edge region and a plurality of projections in the edge region that serve for fixing the receiving device within the housing.

31. The apparatus of claim 23 wherein a first tube connection having the inlet and a second tube connection having the outlet are arranged on the housing.

32. The apparatus of claim 31 wherein the insert is in the form of a substantially rotationally symmetrical nozzle through which the material flows in operation, and the nozzle is so arranged within the housing such that a longitudinal axis of the nozzle is arranged substantially perpendicularly to a longitudinal axis of the housing and coaxially with the first and second tube connections.

33. The apparatus of claim 32 wherein, in the inserted condition, the nozzle comes to bear against an abutment which is provided on the receiving portion of the receiving device and which is arranged downstream of the nozzle in the flow direction.
